(19) United States
(12) Patent Application Publication
(10) Pub. No.: US 2013/0175251 A1
(43) Pub. Date: Jul. 11, 2013

(54) Compensating Heating Element Arrangement for a Vacuum Heat Treating Furnace

(71) Applicant: IPSEN, INC., Cherry Valley, IL (US)

(72) Inventors: Craig A. Moller, Roscoe, IL (US); Hendrik Grobler, Clyde Park, MT (US); Geoffrey Somary, Arlington Heights, IL (US)

(73) Assignee: IPSEN, INC., Cherry Valley, IL (US)

(21) Appl. No.: 13/728,122

(22) Filed: Dec. 27, 2012

Related U.S. Application Data
(60) Provisional application No. 61/581,302, filed on Dec. 29, 2011.

(51) Int. Cl. F27D 19/00

(52) U.S. Cl. CPC F27D 19/00
USPC 219/392

(57) ABSTRACT

A heating element arrangement for a vacuum heat treating furnace is disclosed wherein the heating elements that make up the heating element arrays have different electrical resistances or watt densities at different locations in the heating element arrays. This arrangement allows for placement of heating elements having electrical resistance selected to provide more or less heat as needed in the furnace hot zone to provide better temperature uniformity in the workload. The electrical resistances and watt densities of the heating element arrays are varied by using a first heating element having a geometry in one segment of a heating element array and a second heating element having a different geometry from that of the first heating element in another section of the heating element array.

### CROSS REFERENCE TO RELATED APPLICATION

This application claims the benefit of U.S. Provisional Application No. 61/581,302, filed Dec. 29, 2011, the entirety of which is incorporated herein by reference.

### BACKGROUND OF THE INVENTION

1. Field of the Invention

This invention relates generally to vacuum furnaces for the heat treatment of metal parts and in particular to a heating element arrangement for use in such a vacuum furnace.

2. Description of the Related Art

Many industrial vacuum furnaces for the heat treatment of metal work pieces utilize electrical resistive heating elements. The heating elements are made from different materials depending on the design requirements for the vacuum furnace. Usual heating element materials for high temperature furnaces include graphite and refractory metals such as molybdenum and tantalum. Heating elements for low and intermediate temperatures include stainless steel alloys, nickel-chrome alloys, nickel base superalloys, and silicon carbide. The heating elements are usually arranged in arrays around the interior of the hot zone so that the arrays surround a work load of metal pieces to be heat treated. In this manner, heat can be applied toward all sides of the work load. A known arrangement is shown schematically in FIG. 1 and physically in FIG. 2. The heating elements in each array all have the same electrical resistance and surface area. Therefore, each heating element generates the same amount of heat as every other heating element when energized.

The heating element arrays are connected to provide multiple, separately energized heating zones within the furnace hot zone as shown in FIGS. 1 and 3. Each heating zone includes two or more heating element arrays connected to a single power source, such as an electrical transformer. The transformers are individually controlled to provide more or less electrical current to different heating zones. In this way, the heating zones are trimmable so that more or less heat can be applied to different sections of the work load or in different regions of the furnace hot zone.

The known heating zone arrangements provide a limited ability to trim the amount of heat applied in different regions of the furnace hot zone during a heating cycle. However, many workloads for heat treating do not have uniform geometries or densities either from top-to-bottom or from side-to-side. Moreover, many vacuum furnace hot zones do not have uniform cross sections and there are metallic components that extend into the hot zone which can conduct heat out of the hot zone. The lack of uniform cross sections and the presence of other metallic parts in the hot zone create heat transfer anomalies that result in non-uniform heat transfer from the heating elements to the work load. It would be desirable to be able to more precisely tailor the power, and hence the heat, generated by individual resistive heating elements in the heating element arrays so that heat can be applied to a work load with greater uniformity than is presently achievable.

### SUMMARY OF THE INVENTION

In accordance with the present invention there is provided a heating element arrangement for a vacuum heat treating furnace wherein the heating elements that make up the heating element arrays have different electrical resistances or watt densities at different locations in the heating element arrays. This arrangement allows for placement of heating elements having electrical resistance selected to provide more or less heat as needed in the furnace hot zone to provide better temperature uniformity in the workload. The electrical resistances of the heating element arrays are varied by using a first heating element having a geometry in one segment of a heating element array and a second heating element having a different geometry from that of the first heating element in another section of the heating element array.

### BRIEF DESCRIPTION OF THE DRAWINGS

The foregoing summary as well as the following detailed description will be better understood when read in conjunction with the drawings, wherein:

FIG. 1 is a schematic diagram of three heating element arrays in accordance with the known arrangement;

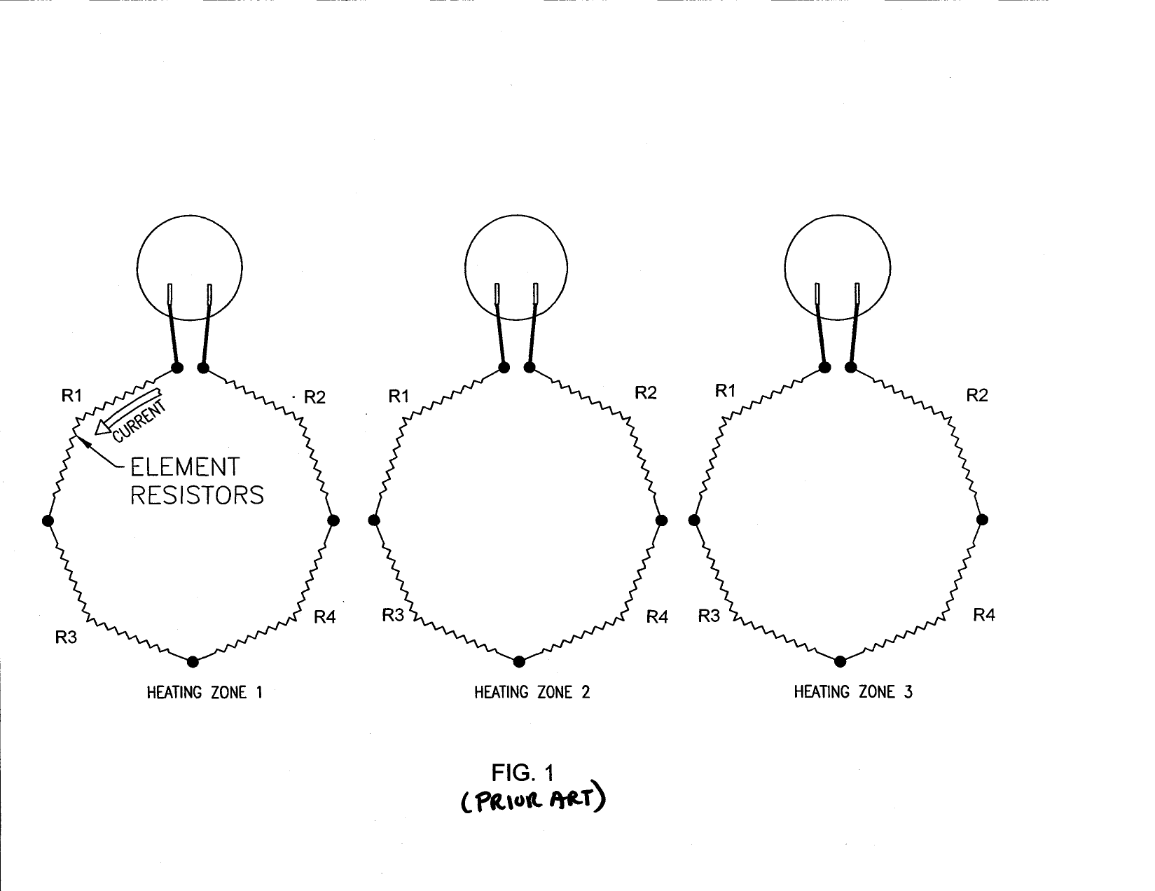

FIG. 2 is an end elevation view in partial section of a known vacuum heat treating furnace;

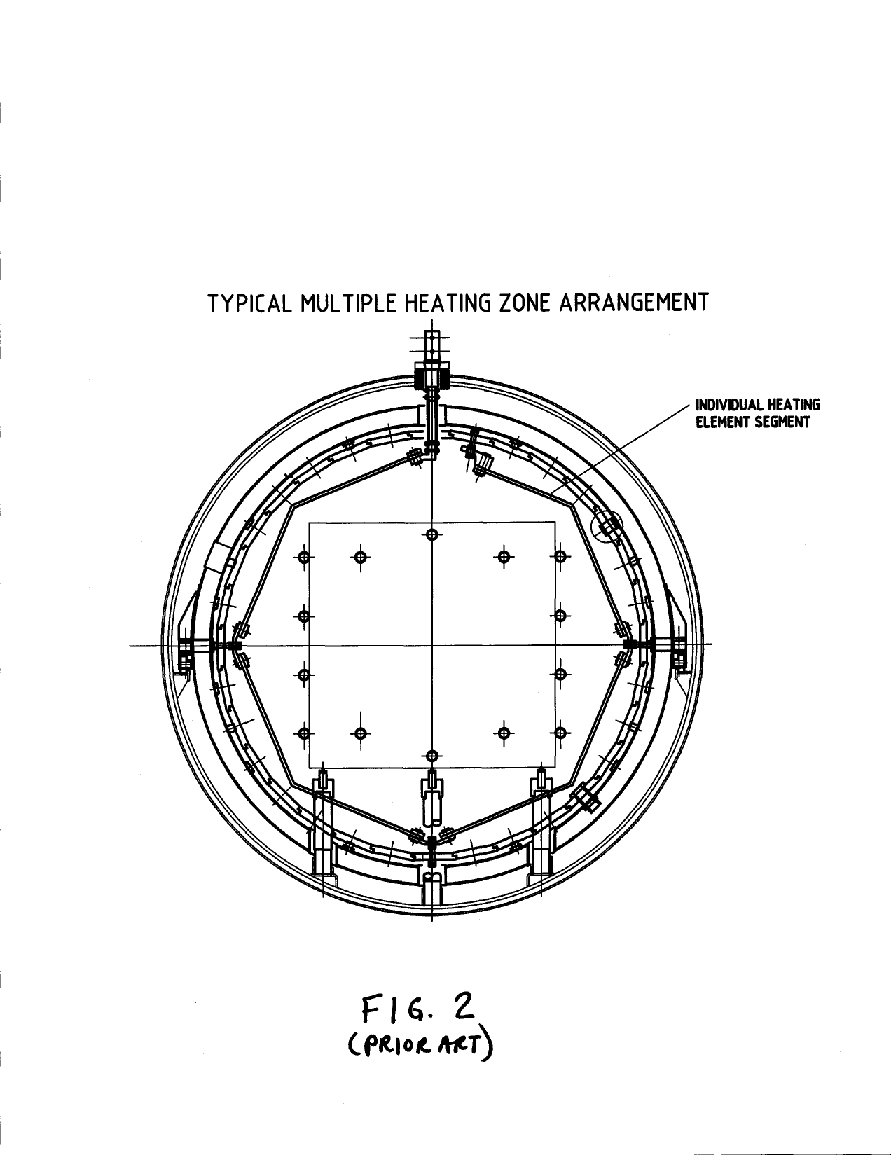

FIG. 3 is a side elevation view in partial section of the vacuum heat treating furnace of FIG. 2;

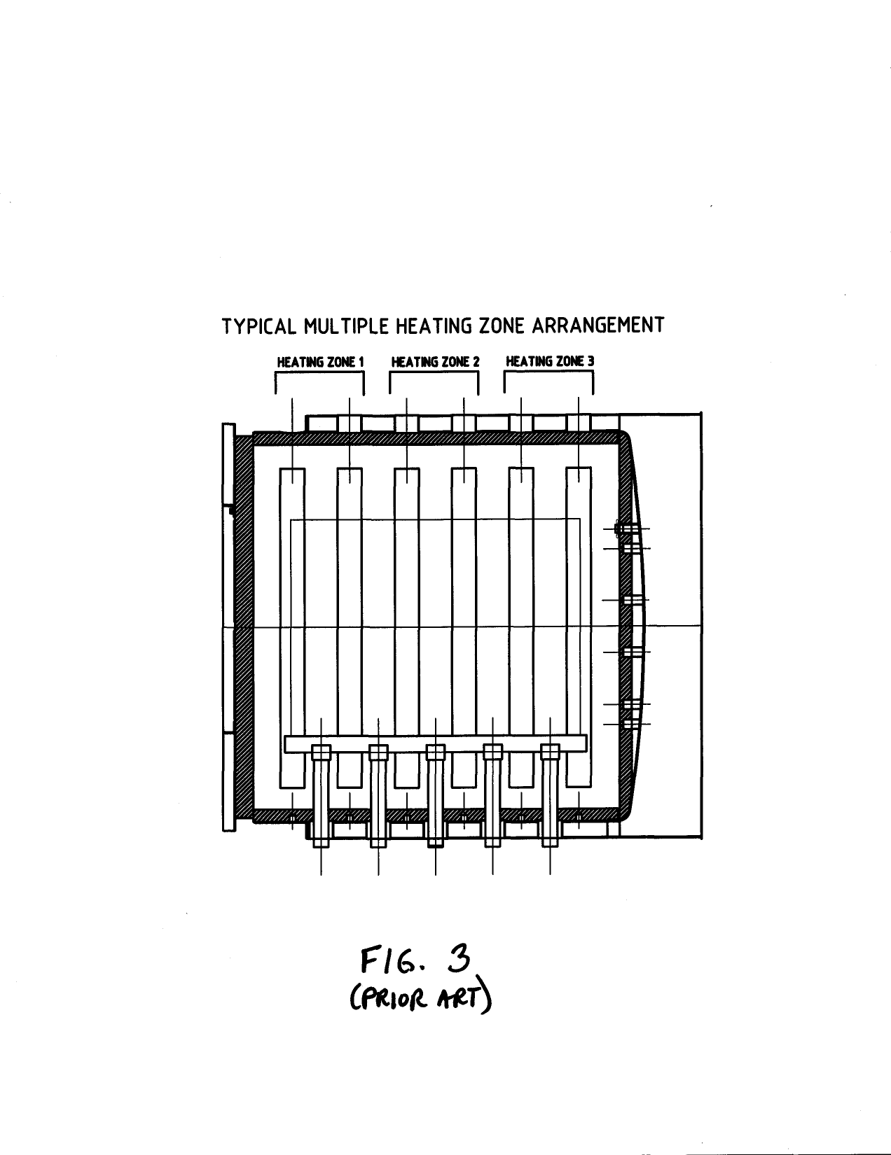

FIG. 4 is a schematic diagram of three heating element arrays in accordance with the present invention; and

FIG. 5 is an end elevation view in partial section of a vacuum heat treating furnace in accordance with the present invention.

### DETAILED DESCRIPTION

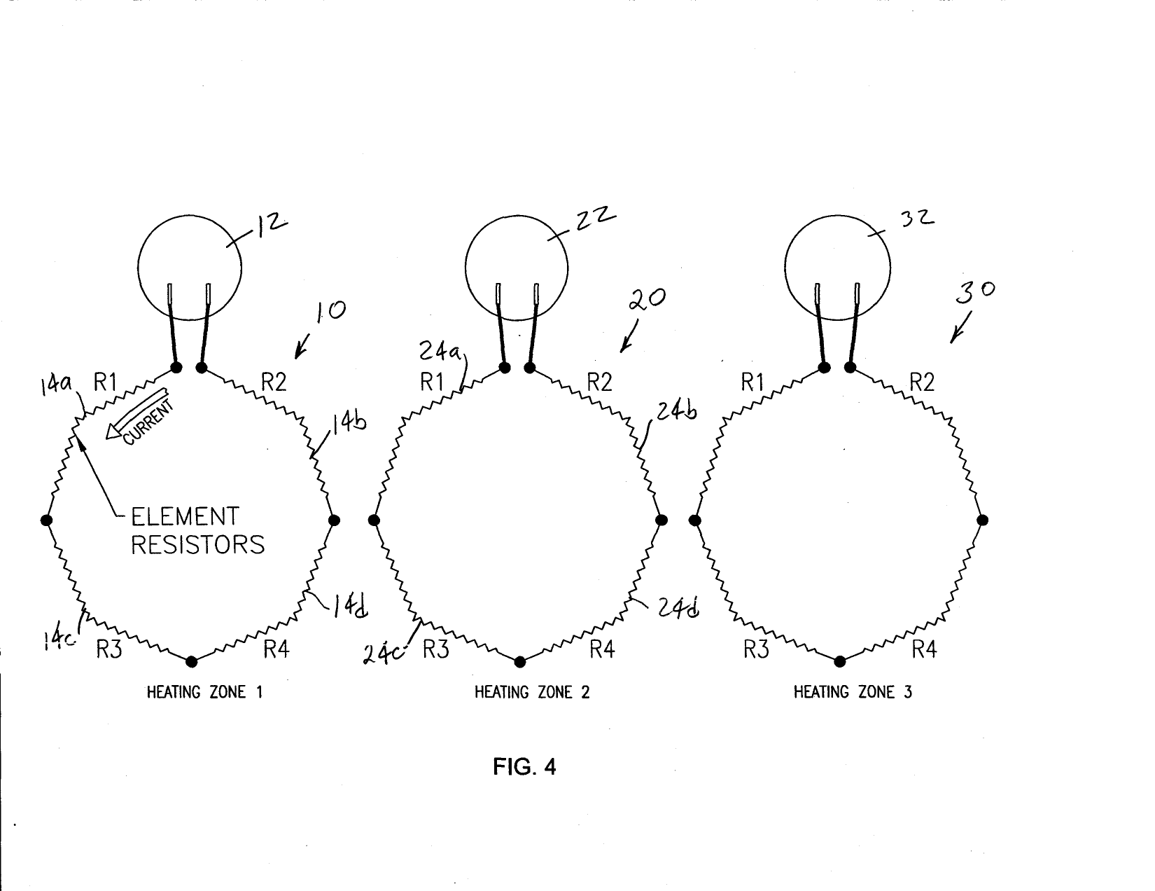

Referring now to FIG. 4, there are shown schematically three heating element arrays 10, 20, and 30 each of which is adapted to provide heat to an area of the hot zone of a vacuum furnace for the heat treating of metal parts. Each heating element array is connected to a transformer 12, 22, and 32, respectively, which provides electric current to the heating element arrays 10, 20, and 30. Each heating element array 10, 20, and 30 is constructed of multiple electrical resistance heating elements. For example, in the embodiment shown in FIG. 4, heating element array 10 is composed of heating elements 14a, 14b, 14c, and 14d which are connected together in series. The ends of heating elements 14a and 14b are connected to transformer 12. Likewise, heating element array 20 is composed of heating elements 24a, 24b, 24c, and 24d that are also connected in series with the ends of heating elements 24a and 24b connected to transformer 22. Heating element array 30 is constructed and connected in a similar manner.

In the arrangement shown in FIG. 4, heating elements 14a and 14b have resistance values R1 and R2, respectively. R1 may be equal to or different from R2. Heating elements 14c and 14d have resistance values R3 and R4. R3 may be equal to or different R4. In accordance with one embodiment of the present invention, R3 is preferably a multiple or a fraction of R1 and R4 is preferably a multiple or a fraction of R2.

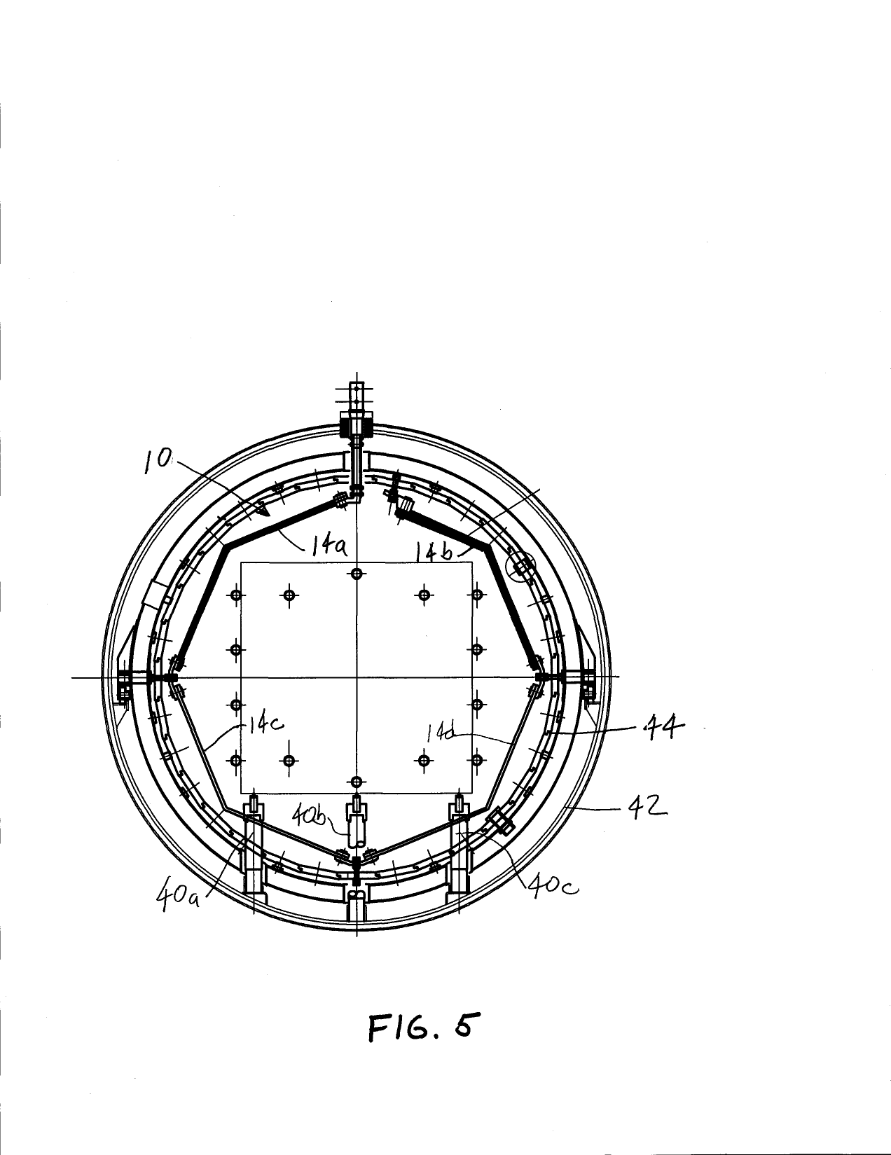

The values of R1, R2, R3, and R4 are determined based on the expected geometry and density of the work load of metal parts to be heated. Alternatively, or in addition, the resistance values are determined with reference to the geometry and construction of the furnace hot zone. Since the power generated by a heating element is based on the known relationship, P=I²·R, once the electric current and the desired power output are selected, the resistance value for the heating element can be readily determined. Electrical resistance of a material is inversely related to the cross section of the material. For strip or flat bar heating elements, the cross section is determined by the thickness and width of the heating element. Whereas, for a round bar heating element, the cross section is determined by the diameter or radius of the heating element. Therefore, the desired resistance value is realized by using a heating element that has a cross section selected to provide the desired amount of electrical resistance in the heating element. For example, if more heat is desired in the lower part of the hot zone, then heating element 14c, heating element 14d, or both are formed to have cross sections that are smaller than the cross section of heating element 14a and/or heating element 14b, as shown in FIG. 5. Alternatively, the heating element(s) may have the same or substantially the same cross sections, but different surface area arrangements to provide different watt densities among the heating elements. If more heat is desired in the upper part of the hot zone, then heating element 14c, heating element 14d, or both are formed to have cross sections that are greater than the cross section of heating element 14a and/or heating element 14b. In this manner, by using heating elements of appropriate cross section for heating elements 14a-14d, the heat produced within the vacuum furnace hot zone is tailored to provide optimized heat transfer to all areas of the work load and to avoid non-uniform heat transfer that results in insufficient heating of some portions of the work load.

For example, in the embodiment shown in FIG. 5, hearth support posts 40a, 40b, and 40c that support the work load extend from the furnace wall 42 through the hot zone wall 44. Thus, the support posts provide a means for significant heat transfer out of the hot zone. In accordance with the present invention, the heating elements 14c and 14d are formed to provide resistance values R3 and R4 that are selected to be greater (e.g., 25% higher) than the resistance values R1 and R2 of heating elements 14a and 14b. When the heating element array 10 is energized the elements 14c and 14d will produce more heat than heating elements 14a and 14b because the resistance values R3 and R4 are higher than the resistance values R1 and R2 and the same electric current flows through all four of the heating element segments. In this example, heating elements 14c and 14d produce higher power (i.e., heat) at the bottom of the hot zone which compensates for additional heat losses out of the hot zone through the hearth posts. This helps to improve the heating uniformity in the hot zone.

The concept of compensating heating elements in accordance with the present invention can be applied to any resistive heating elements made of any material. It can also be applied to any heating element configuration (series or parallel), to any element shape, element cross section, and to hot zone shape. It will also be appreciated that the use of the technique described herein can be used in combination with the known techniques for front-to-rear or top-to-bottom manual electronic trimming described above.

1. A vacuum heat treating furnace for the heat treatment of metal parts comprising:
a pressure/vacuum vessel;
a hot zone positioned inside said pressure vessel;
a heating element array positioned inside said hot zone; and
a source of electric energy connected to said heating element array;
said heating element array comprising:
a first heating element located in a first region of the hot zone and having a geometry selected to provide a first watt density;
a second heating element located in a second region of the hot zone and having a geometry selected to provide a second watt density,
wherein the first watt density value is selected such that said first heating element provides a first quantity of heat and the second watt density value is selected such that said second heating element provides a second quantity of heat different from the first quantity when said first and second heating elements are energized by said electric energy source;
whereby the first quantity of heat is provided in the first region of the hot zone and the second quantity of heat is provided the second region of the hot zone.

2. A vacuum heat treating furnace as set forth in claim 1 wherein the geometry of the first heating element is the cross section of the first heating element.

3. A vacuum heat treating furnace as set forth in claim 2 wherein the geometry of the second heating element is the cross section of the second heating element.

4. A vacuum heat treating furnace as set forth in claim 1 wherein the geometry of the first heating element is the surface area of the first heating element.

5. A vacuum heat treating furnace as set forth in claim 2 wherein the geometry of the second heating element is the surface area of the second heating element.

6. A method of making a vacuum heat treating furnace for the heat treatment of metal parts comprising the steps of:
providing a pressure/vacuum vessel;
installing a hot zone inside said pressure vessel;
forming a first heating element having a geometry selected to provide a first watt density;
forming a second heating element having a geometry selected to provide a second watt density;
connecting the first and second heating elements to form a heating element array;
installing the heating element array inside said hot zone such that the first heating element is located in a first region of the hot zone and the second heating element is located in a second region of the hot zone; and
connecting a source of electric energy to said heating element array;
wherein the first watt density is selected to provide a first quantity of heat and the second watt density is selected to provide a second quantity of heat different from the first quantity when said first and second heating elements are energized by said electric energy source;
whereby the first quantity of heat is provided in the first region of the hot zone and the second quantity of heat is provided the second region of the hot zone.

7. A method of making a vacuum heat treating furnace as set forth in claim 6 wherein the step of forming the first heating element comprises the step of forming the first heating element to have a cross section that provides the first watt density.

8. A method of making a vacuum heat treating furnace as set forth in claim 7 wherein the step of forming the second heating element comprises the step of forming the second heating element to have a cross section that provides the second watt density.

9. A method of making a vacuum heat treating furnace as set forth in claim 6 wherein the step of forming the first heating element comprises the step of forming the first heating element to have a surface area that provides the first watt density.

10. A method of making a vacuum heat treating furnace as set forth in claim 9 wherein the step of forming the second heating element comprises the step of forming the second heating element to have a surface area that provides the second watt density.
